(19) United States
(12) Patent Application Publication
(10) Pub. No.: US 2005/0199784 A1
(43) Pub. Date: Sep. 15, 2005

(54) Light to PWM converter

(76) Inventors: Rizal Jaffar, Masjid Tanah (MY); Kevin Lim Len-Li, Taiping (MY); Lee Joon Chok, Kuching (MY)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/799,126

(22) Filed: Mar. 11, 2004

(51) Int. Cl. H01J 40/14

(52) U.S. Cl. 250/214 R

(57) ABSTRACT

Conversion of light intensity to digital signal. Current output of a photodiode representing light intensity is converted to a voltage and provided as one input to a comparator. A sawtooth generator feeds the other comparator input. The output of the comparator is a pulse width modulated (PWM) digital signal where the pulse width is proportional to light intensity. The sawtooth generator may be synchronized to an external source.

### TECHNICAL FIELD

Embodiments in accordance with the invention relate generally to optical to electrical converters. More particularly, the invention relates to optical to digital converters.

### BACKGROUND

Many devices require the conversion of optical properties such as intensity to an electrical signal. Common solutions to the conversion problem use conventional analog to digital converters where an analog input from a sensor such as a photodiode is supplied to a analog to digital converter (ADC) which produces a multi-bit digital output representing the intensity level of the input signal. Implementations of such a solution require careful attention be paid to layout and signal paths. Analog signal conditioning is required between the photodiode and the analog to digital converter. A stable reference voltage must be supplied to the analog to digital converter, as well as a conversion clock. All this circuitry takes up space, and costs money.

### SUMMARY

In accordance with the invention, a light to PWM converter is provided. Photocurrent from a photodiode is converted to a voltage by an amplifier such as a transimpedance amplifier. The output voltage of the amplifier representing light intensity is fed to one input of a comparator. A sawtooth generator feeds the other input of the comparator. The digital output of the comparator is a pulse width modulated signal, the pulse width proportional to light level. The sawtooth generator may be synchronized to an external source.

### BRIEF DESCRIPTION OF THE DRAWINGS

The invention will best be understood by reference to the following detailed description of embodiments in accordance with the invention when read in conjunction with the accompanying drawings, wherein:

FIG. 1 shows a block diagram of a light to PWM converter according to the present invention,

FIG. 2 shows waveforms of the invention, and

FIG. 3 shows a second embodiment of the invention.

### DETAILED DESCRIPTION

The invention relates to light to digital conversion. The following description is presented to enable one skilled in the art to make and use the invention, and is provided in the context of a patent application and its requirements. Various modifications to the disclosed embodiments will be readily apparent to those skilled in the art, and the generic principles herein may be applied to other embodiments. Thus, the invention is not intended to be limited to the embodiments show but is to be accorded the widest scope consistent with the appended claims and with the principles and features described herein.

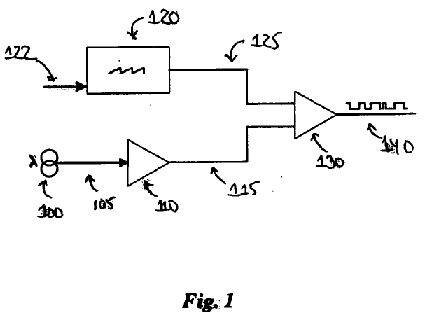

With reference now to the figures and in particular with reference to FIG. 1, photodiode 100 converts light to photocurrent 105. This small photocurrent is converted to a voltage by transimpedance amplifier 110. Transimpedance, also known as transresistance, amplifiers are well known to the art, for example, “The Art of Electronics” second edition by Horowitz and Hill, pp. 79, 184, 235, 962, 1039. The output voltage 115 of transimpedance amplifier 110 is provided as one input to comparator 130.

Sawtooth generator 120 provides sawtooth waveform 125 as the other input to comparator 130. The output of a sawtooth generator ramps from a first low voltage to a second peak voltage, resetting quickly to the first low voltage. Sawtooth generators are well known to the art, typically comprising a current source charging a timing capacitor until a threshold voltage is met, at which point the timing capacitor is discharged. In an ideal sawtooth waveform, the voltage ramp is linear, and the reset time very short. Sawtooth generator 120 also has optional synchronization input 122. This input may be used to synchronize the sawtooth waveform generated to external signals.

Comparator 130 compares sawtooth waveform 125 with reference voltage 115 representing light intensity detected by photodiode 100. The output 140 of the comparator is a digital signal. The output of the comparator is high when reference voltage 115 is higher than sawtooth waveform 125.

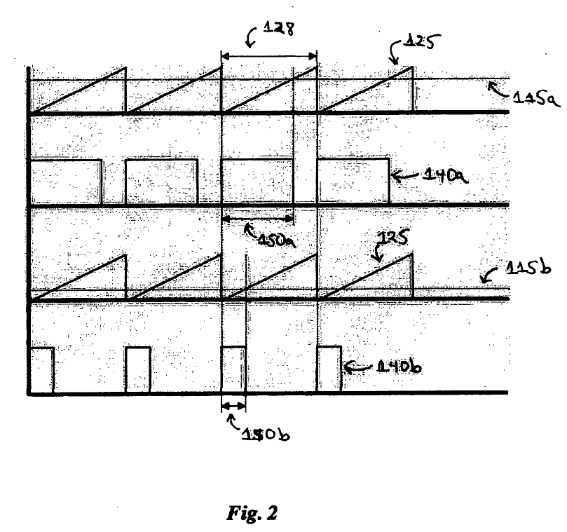

This is shown in FIG. 2. Line 115a shows a voltage representing a high light level. Waveform 125 shows the sawtooth waveform from sawtooth generator 120 of FIG. 1. The period of sawtooth generator 120 is shown as 128 in FIG. 2. PWM waveform 140a represents the resulting pulse width modulated output of comparator 130. The pulse width of this waveform is shown as 150a. The output of comparator 130 is high when input 115a to comparator 130 is higher than sawtooth waveform 125 from sawtooth generator 120. Line 115b shows a voltage representing a low light level. When compared to sawtooth waveform 125, PWM waveform 140b results, its pulse width represented by 150b. As voltage 115 increases, representing increasing light intensity, the pulse width of output signal 140 increases. The linearity of this response depends on the linearity of sawtooth generator 120.

As shown, the on-time of the output waveform is proportional to the input light level. By reversing the inputs to the comparator, or inverting the output of the comparator, a signal in which the off-time of the output waveform is proportional to the light level is generated.

While the invention may be implemented in discrete components, it may be implemented in integrated form with all components on a common substrate. This can result in a three or four pin module, with ground, positive supply, PWM output, and optionally sawtooth synchronization input. This integration need not be in the form of a single integrated circuit, but may be an intermediate form such as packaged or unpackaged components on one or both sides of a substrate. Depending on the size of the timing capacitor used in the sawtooth generator, one or more pins may be provided for allowing this component to be located external to the substrate. In an alternate embodiment, the processing components, all but the photodiode, may be integrated into a single package, connecting to an external photodiode.

In use, the spectral response of the system is determined by the photodiode and the optical properties of its packaging. In many applications, it may be desirable to shape the spectral response of the photodiode by placing optical filtering material in the optical path.

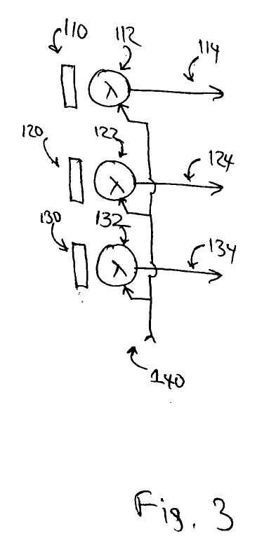

FIG. 3 shows an embodiment using three sensors according to the present invention. Red filter 110 filters light to sensor 112 producing red PWM output 114 proportional to the level of red light. Green filter 120 similarly filters light to sensor 122, which produces green PWM output 124. Blue filter 130 filters light to sensor 132, which produces blue PWM output 134. Also shown is optional synchronization line 140, causing sensors 112, 122, and 132 to produce synchronized PWM output signals. Depending on the details of the implementation, synchronization may be provided through applying a synchronization pulse as previously described, or may be obtained by driving the comparators in the group of sensors from the same sawtooth generator.

The foregoing detailed description of the present invention is provided for the purpose of illustration and is not intended to be exhaustive or to limit the invention to the precise embodiments disclosed. Accordingly the scope of the present invention is defined by the appended claims.

1. Apparatus for converting an optical signal to a digital signal comprising:
a photodiode converting an optical signal to a current;
a transimpedance amplifier converting the photodiode current to a voltage,
a sawtooth generator producing a sawtooth wave, and
a comparator comparing the sawtooth wave with the voltage output of the transimpedance amplifier, producing a pulse width modulated digital output.

2. The apparatus of claim 1 where the sawtooth generator also includes a synchronization input.

3. The apparatus of claim 1 where the transimpedance amplifier, sawtooth generator, and comparator are in a common package.

4. The apparatus of claim 1 where the photodiode, transimpedance amplifier, sawtooth generator, and comparator are in a common package.

5. The apparatus of claim 2 where the photodiode further includes an optical filter.

6. The apparatus of claim 5 wherein a plurality of converter units, each converter unit comprising a photodiode with an optical filter, transimpedance amplifier, and comparator, are driven by a common sawtooth generator.

7. The apparatus of claim 6 where the plurality of converter units are driven by a sawtooth generator internal to one of the converter units.

8. The apparatus of claim 6 where the plurality of converter units are driven by a sawtooth generator external to all of the converter units.

9. The apparatus of claim 5 wherein a plurality of converter units, each converter unit comprising a photodiode with an optical filter, transimpedance amplifier, comparator, and sawtooth generator, are synchronized.

10. A method of converting an optical signal to a digital signal comprising:
converting the optical signal to a current,
converting the current representing the optical signal to a voltage representing the optical signal,
generating a sawtooth wave, and
comparing the sawtooth wave to the voltage representing the optical signal and producing a digital pulse width modulated output.

11. The method of claim 10 where the sawtooth wave is synchronized to an external signal.

12. The method of claim 10 further including the step of filtering the optical signal.
